(19) United States
(12) Patent Application Publication
(10) Pub. No.: US 2026/0324848 A1
(43) Pub. Date: Oct. 22, 2026

(54) Toilet Brush

(71) Applicant: Bestview Investments Pty Ltd, Hamilton Hill (AU)

(72) Inventors: Guiseppe PITTORINI, Hamilton Hill (AU); Aldo WERJUTINA, Scarborough (AU); Edward Joseph Khoury, Bateman (AU)

(21) Appl. No.: 19/468,531

(22) Filed: Feb. 3, 2026

Related U.S. Application Data
(63) Continuation of application No. 17/919,528, filed on Apr. 20, 2021, now abandoned.

(30) Foreign Application Priority Data
Apr. 21, 2020 (AU) 2020901253
Dec. 9, 2020 (AU) 2020904562

(51) Int. Cl. A46B 11/00; A46B 5/00; A46B 15/00; A46B 17/08; A47K 11/10

(52) U.S. Cl. CPC A46B 11/0068; A46B 5/0095; A46B 11/0013; A46B 11/0065; A46B 15/0095; A46B 17/08; A47K 11/10; A46B 2200/304

(57) ABSTRACT

A toilet brush (10) comprising a shaft (12) having a handle (14) at a first end (18) and a brush head (16) at a second end (19). A cavity (22) is provided within the handle (14) for receiving a tablet sheet (26). Tablets (28) may be dispensed by pushing on pockets (30) in the tablet sheet (26) through apertures (24) in the handle (14). The shaft (12) includes a bore (20) extending from the handle (14) to the brush head (16) such that, when dispensed from the sheet (26), the tablets (28) can fall through the bore (20) such that the tablets may dissolve.

### FIELD OF THE INVENTION

The present invention relates to a toilet brush.

### BACKGROUND TO THE INVENTION

Toilet brushes generally comprise a simple handle having bristles at one end. The bristles are used to clean in the inner surface of the toilet bowl and a cleaning solution is often poured into the toilet at the same time. This requires handling both the toilet brush and the bottle of cleaning solution. This is generally undesirable given that chemicals used to clean toilets are best kept away from contact with the skin.

The present invention relates to a toilet brush having features aimed at allowing application of a cleaning substance into the toilet in a manner which is quick and easy and keeps the cleaning chemicals away from the hands of the user. The toilet brush also includes features to improve the ability to clean around the curved inner surfaces of the toilet bowl.

### SUMMARY OF THE INVENTION

According to one aspect of the present invention there is provided a toilet brush comprising:
shaft having a handle at a first end thereof and a brush head at a second end thereof;
a cavity within the handle for receiving a tablet sheet, the tablet sheet including a plurality of pockets in which tablets are received and a cover sheet enclosing the pockets such that the tablets may be dispensed by pushing on the pockets to break the cover sheet; and
a plurality of apertures in the handle through which the pockets of the sheet are accessible;
wherein the shaft includes a bore extending from the handle to adjacent the brush head such that, when dispensed from the sheet, the tablets can fall through the bore such that the tablets may dissolve into a toilet.

Preferably the brush head includes an inner tube in communication with the bore of the shaft such that the tablet falls into the inner tube.

Preferably a lower end of the inner tube is located adjacent an outlet in the brush head such that the tablet may fall through the inner tube and outwardly from the brush head through the outlet.

Preferably a flexible covering member is provided in the handle having flexible domes extending outwardly through the apertures such that the flexible domes may be depressed to push the tablet outwardly from the tablet sheet into the cavity.

In a preferred embodiment, the apertures are provided in a line extending along the length of the handle.

Preferably the handle comprises a handle body connected to the shaft and a removable handle cover and wherein the apertures are provided in the handle cover.

Preferably the handle cover comprises an elongate member extending from the first end of the handle to the second end of the handle which is removable by sliding the handle cover longitudinally away from the shaft.

In a preferred embodiment, the cavity is provided with a plurality of tabs to engage into indents in edges of the tablet sheet to locate the tablet sheet such that the pockets extend through the apertures.

Preferably the indents are provided in opposed longitudinal edges of the tablet sheet.

Preferably the tablets include a foaming compound to promote outward expansion of the cleaning substance and a colouring.

In accordance with a second aspect of the present invention, there is provided a toilet brush comprising:
a shaft having a handle at a first end;
a flexible inner tube extending outwardly from a second end thereof; and
a plurality of body segments each including cleaning protrusions extending outwardly from around the periphery thereof;
wherein each of the body segments includes a central hole through which the inner tube is received such that flexing of the inner tube in use allows the angle of the cleaning protrusions on each of the body segments to move out of a plane perpendicular to a longitudinal axis of the shaft, thereby allowing a brush head formed from the adjacent body segments to curve in use.

Preferably the body segments each comprises a circular plate arranged such that centres of the body segments are located on a common longitudinal axis.

Preferably the cleaning protrusions comprise both bristles and flexible cleaning fins.

Preferably the cleaning fins comprise flexible discs extending outwardly from the periphery of the body segments having arm portions extending radially outwardly therefrom.

Preferably each of the body segments is provided alternately with either bristles or fins.

In accordance with a third aspect of the present invention, there is provided a tablet sheet for dispensing toilet cleaning tablets comprising: a plurality of pockets arranged along the length of the tablet sheet from a first end to a second end, each of the pockets being for receiving a dissolvable tablet;
a cover sheet extending across a first side of the tablet sheet to enclose each of the pockets to retain the tablets; and
one or more indents in sides of the tablet sheet to receive lugs in a handle of a toilet brush in order to locate the sheet relative to the handle.

Preferably the indents are provided in opposed longitudinal sides of the tablet sheet.

Preferably indents are provided in upper and lower ends of the tablet sheet.

Preferably the tablets include a foaming compound to promote outward expansion of the cleaning substance.

Preferably the tablets include a colouring.

### BRIEF DESCRIPTION OF THE DRAWINGS

The invention will now be described, by way of example, with reference to the following drawings, in which:

FIG. 1 is an upper perspective view of a toilet brush in accordance with the present invention;

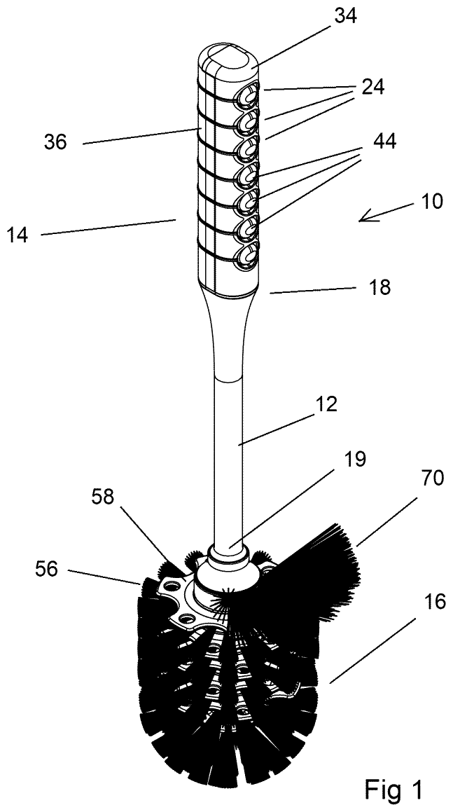

FIG. 2 is a front view of the toilet brush of FIG. 1;

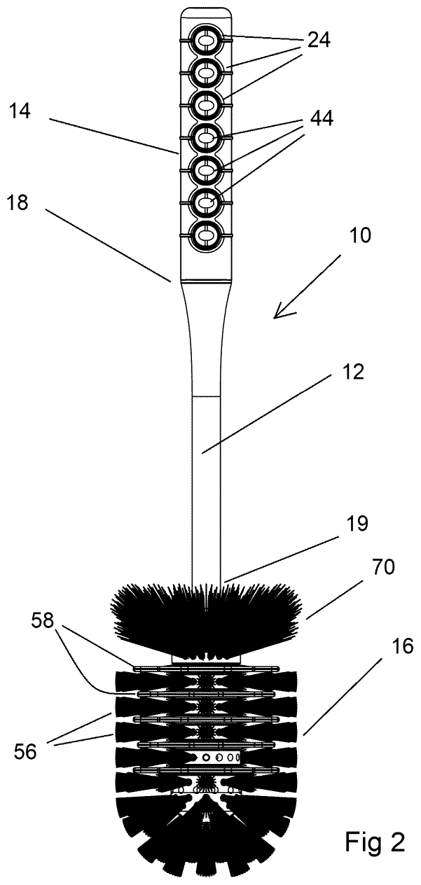

FIG. 3 is a side view of the toilet brush of FIG. 1;

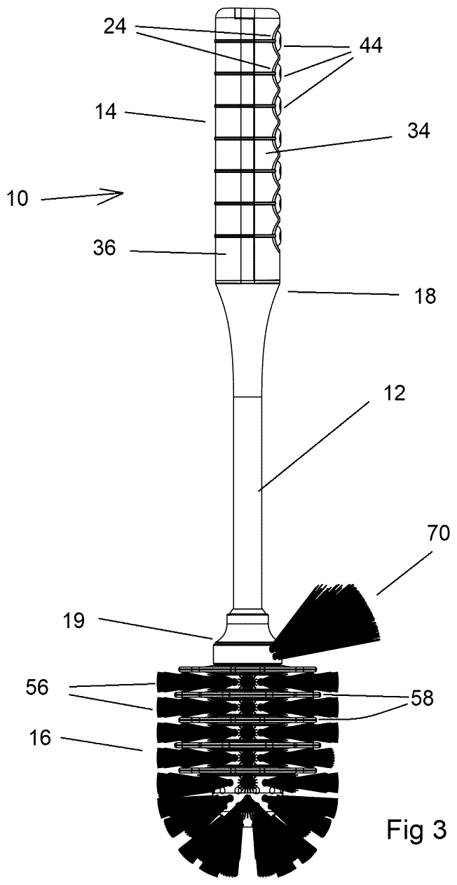

FIG. 4 is a partially exploded view of the toilet brush of FIG. 1;

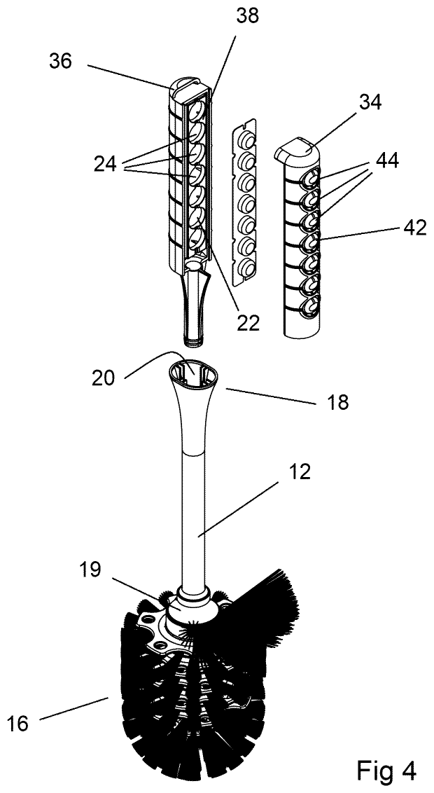

FIG. 5 is an upper perspective view of the toilet brush of FIG. 1 in a stand;

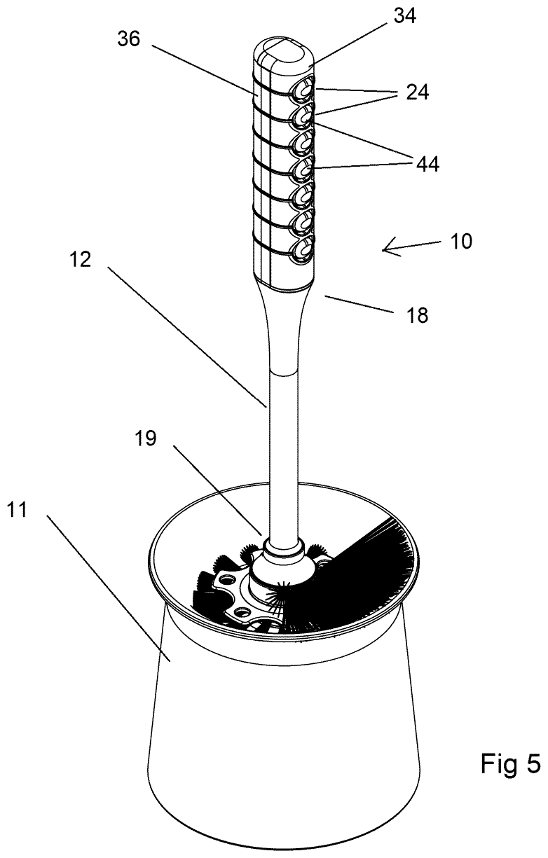

FIG. 6 is a side cross-sectional view of the toilet brush of FIG. 1 in the stand;

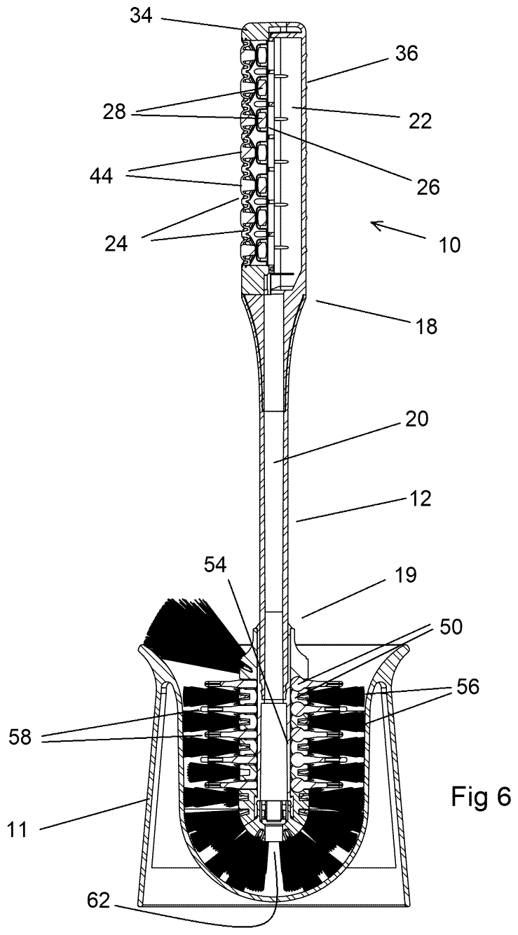

FIG. 7 is an upper perspective view of the toilet brush with the handle removed;

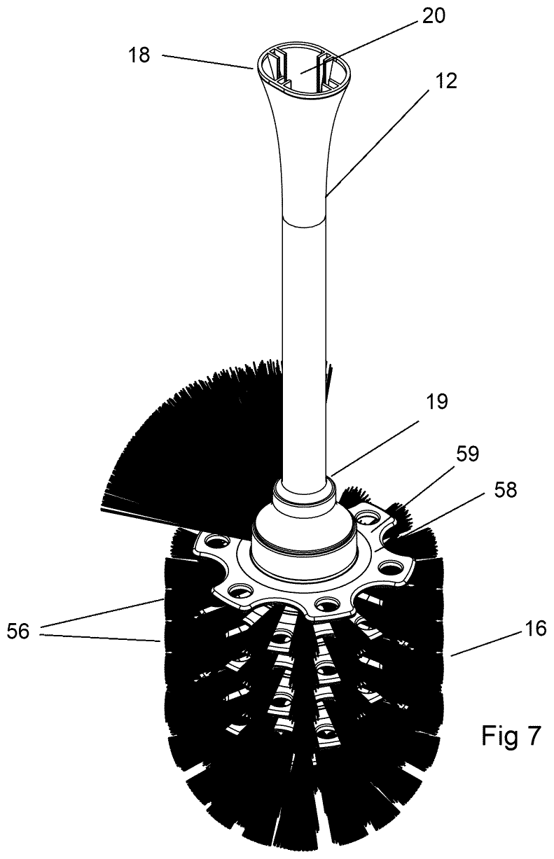

FIG. 8 is an exploded view of the shaft and the brush head:

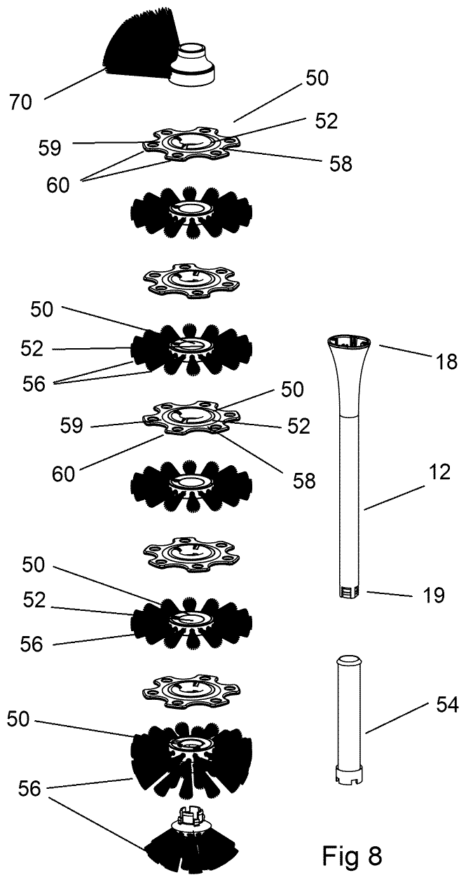

FIG. 9 is an exploded view of the handle with the handle cover removed;

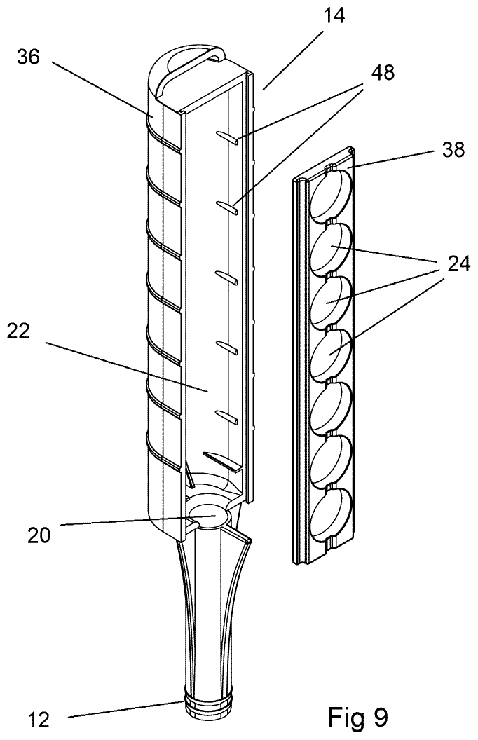

FIG. 10 is an exploded view of the handle cover;

FIG. 11 is an upper perspective view of the tablet sheet;

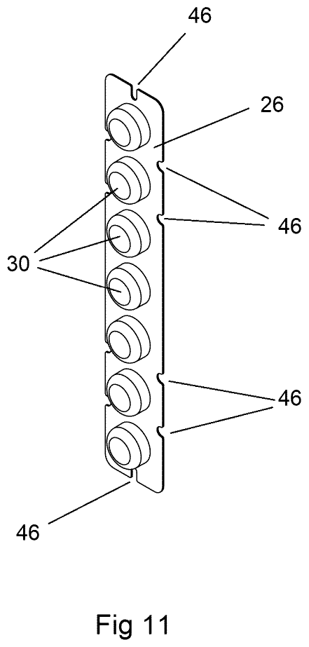

FIG. 12 is a front view of the tablet sheet;

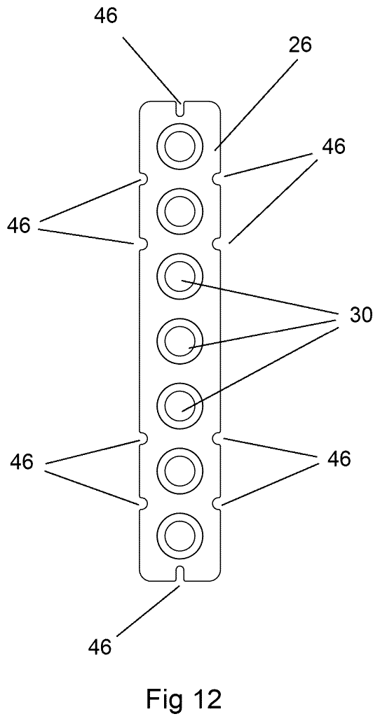

FIG. 13 is a side cross-sectional view of the tablet sheet;

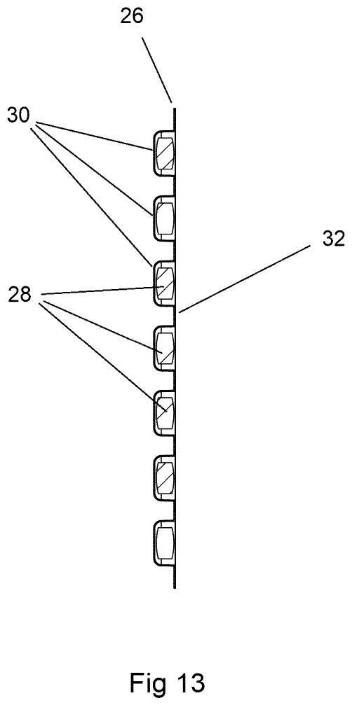

FIG. 14 is a view of the handle prior to removing the handle cover;

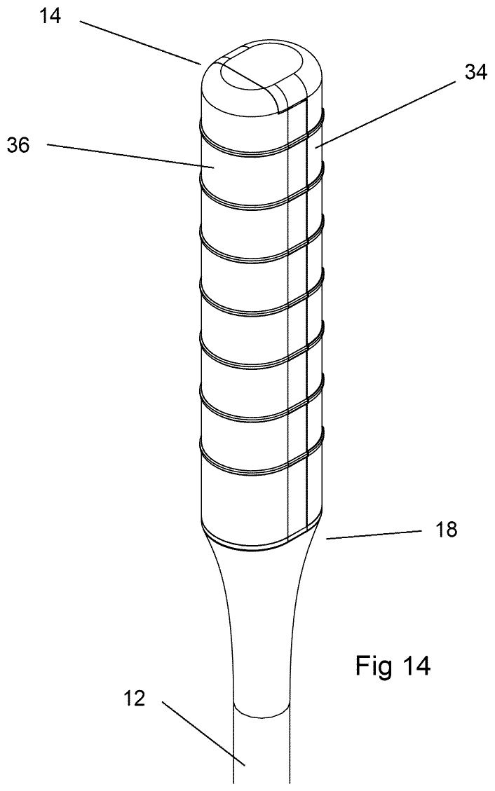

FIG. 15 is a view showing the handle cover opened prior to insertion of the tablet sheet;

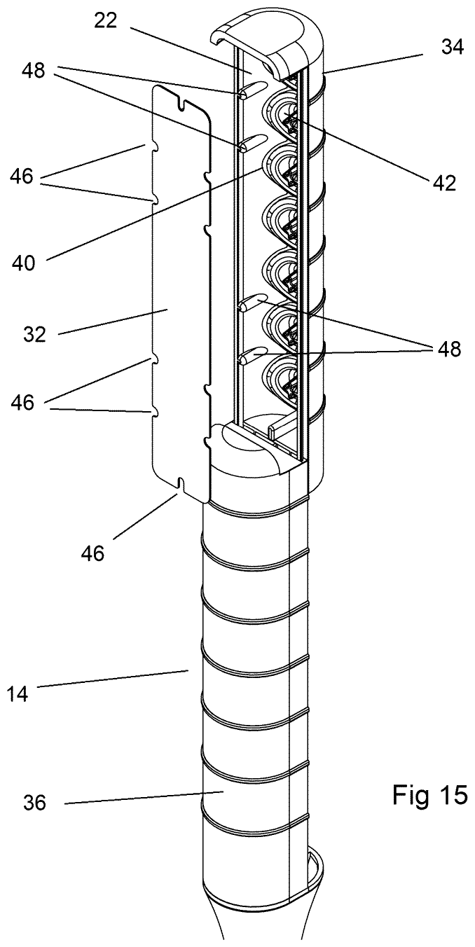

FIG. 16 is a view perspective of the handle with the handle cover opened and the tablet sheet inserted; and

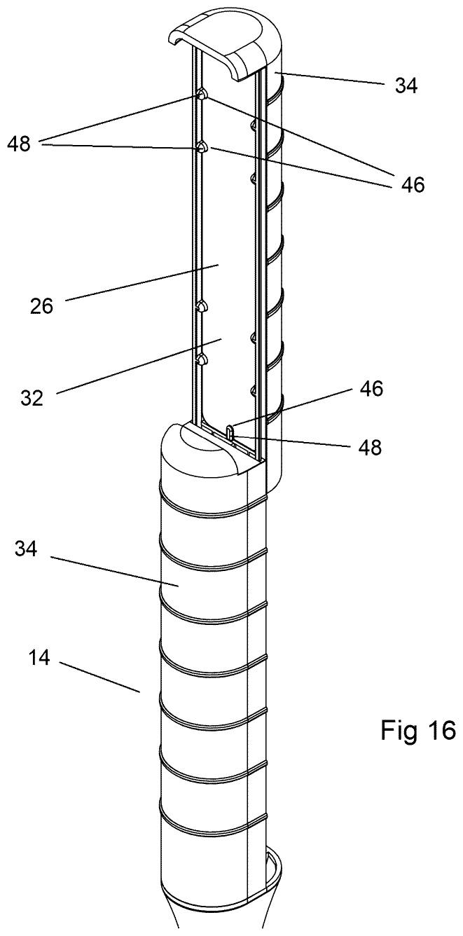

FIG. 17 is a rear view of the handle with the handle cover opened and the tablet sheet inserted.

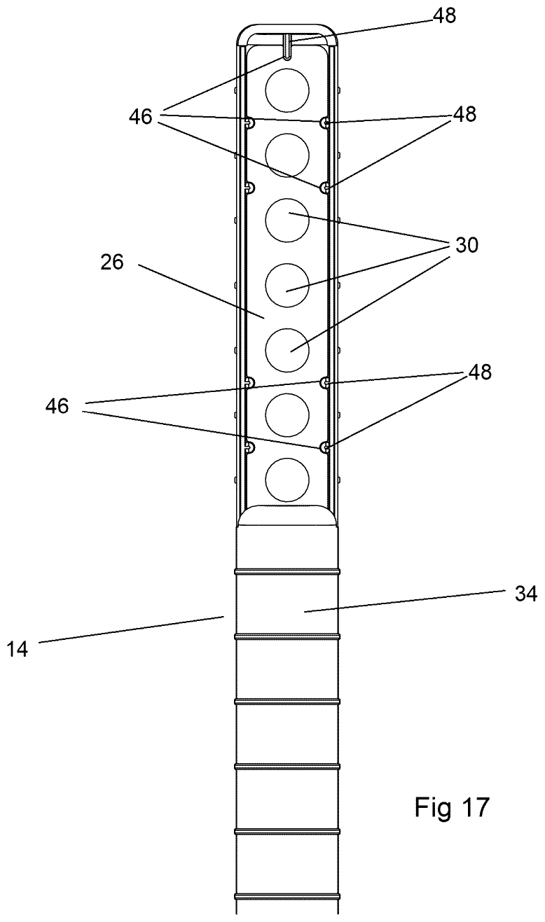

### DETAILED DESCRIPTION OF PREFERRED EMBODIMENTS

Referring to the Figures, there is shown a toilet brush 10 comprising generally a shaft 12 having a handle 14 at a first end 18 and a brush head 16 at a second end 19. The handle 14 is provided for holding and manipulating the toilet brush 10 such that the brush head 16 may be used to clean an inner surface of a bowl of a toilet. The toilet brush 10 may be stored when not in use in a stand 11.

The shaft 12 comprises a tubular member such that the shaft 12 includes a bore 20 extending from the first end 18 to the second end 19 thereof. The handle 14 includes an internal cavity 22 such that the cavity 22 is in communication with the bore 20 of the shaft 12 at the first end 18 of the shaft 12.

The handle 14 comprises an elongate tubular member having a first end connected to the first end 18 of the shaft 12. The first end of the handle 14 is open such that the cavity 22 within the handle 14 is connected to the bore 20 of the shaft 12. A second end of the handle 14 is closed to define the upper end of the cavity 22.

The handle 14 includes a plurality of apertures 24 therein. The apertures 24 in the embodiment shown are arranged in a line extending between the first and second ends of the handle 14. The cavity 22 of the handle 14 is provided to receive a tablet sheet 26 containing tablets 28. Each of the tablets 28 is formed from a dissolvable cleaning substance. The cleaning substance is preferably provided for cleaning and disinfecting the interior of the bowl of the toilet once dissolved.

The tablet sheet 26 includes a plurality of pockets 30 extending outwardly from a first side thereof such that each of the pockets 30 is provided for receiving one of the tablets 28. The tablet sheet 26 also includes a cover sheet 32 extending across the second side thereof. The cover sheet 32 seals across each of the pockets 30 such that the tablets 28 are retained within the pockets 30. The cover sheet 32 is frangible such that depressing one of the pockets 30 pushes the tablet 28 outwardly through the cover sheet 32.

The configuration of the pockets 30 in the tablet sheet 26 corresponds to the configuration of the apertures 24 in the handle 14. The tablet sheet 26 may therefore be inserted into the cavity 22 of the handle 14 such that each of the pockets 30 extends outwardly through one of the apertures 24 such that the pockets 30 are accessible from externally of the handle 14. In embodiment shown, the tablet sheet 26 therefore comprises an elongate tablet sheet having a plurality of pockets 30 arranged in a line.

The handle 14 in the embodiment shown comprises a handle body 36 connected to the shaft 12 and a handle cover 34. The handle cover 34 is attachable to and removable from the handle body 36 to allow access to the cavity 22. In embodiment shown, the handle cover 34 comprises an elongate member extending from the first end of the handle 14 to the second end of the handle 14. The handle cover 34 may be disconnected from the handle body 36 by sliding the handle cover 34 longitudinally away from the shaft 12.

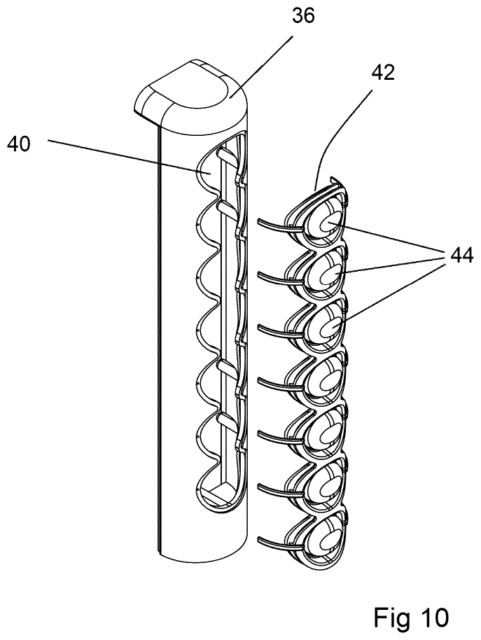

The apertures 24 in embodiment shown are provided in the handle cover 34. The tablet sheet 26 may therefore be positioned in place within the handle 14 by removing the handle cover 34, inserting the tablet sheet 26 such that the pockets 30 extend outwardly through the apertures 24 and then replacing the handle cover 34. In embodiment shown, the apertures 24 are defined by a frame 38. The handle cover 34 is provided with an elongate slot 40 extending along the length thereof (as can be seen in FIG. 10). The frame 38 comprises an elongate member having the apertures 24 therein and which is located adjacent an inner surface of the handle cover 34 such that the apertures 24 are located adjacent the slot 40. A flexible covering member 42 is secured between the frame 38 and the slot 40. The flexible covering member 42 includes flexible domes 44 extending outwardly of the apertures 24 to receive the pockets 30 of the tablet sheet 26. The flexible domes 44 may be depressed inwardly to engage the pockets 30.

The tablet sheet 26 includes a plurality of indents 46 in edges thereof. In the embodiment shown, the indents 46 are provided in opposed longitudinal edges of the tablet sheet 26. The indents 46 are provided to receive tabs 48 provided within the cavity 22 of the handle 14. The tabs 48 are received within the indents 46 to locate the tablet sheet 26 correctly within the cavity 22 such that the pockets 30 align correctly with the apertures 24. Indents 46 are also provided in upper and lower edges of the tablet sheet 46. The indents 46 in the upper and lower edges receive tabs 48 provided at upper and lower ends of the frame 38.

The brush head 16 includes a plurality of cleaning protrusions extending outwardly therefrom. The cleaning protrusions are provided to engage an inner surface of the bowl of the toilet for cleaning. The brush head 16 in the embodiment shown comprises a plurality of body segments 50. The body segments 50 each comprises a circular plate having a central hole 52 therein. The body segments 50 are arranged adjacent each other such that centres of the body segments 50 are located on a common longitudinal axis. The cleaning protrusions are provided extending outwardly from the periphery of each of the body segments 50.

The toilet brush 10 is provided with an inner tube 54 connectable to the second end 19 of the shaft 12. The inner tube 54 is formed from a flexible material, such as a suitably flexible plastic and is oriented such that a central elongate opening of the inner tube 54 is in communication with the bore 20 of the shaft 12. The central holes 52 of the body segments 50 receive the inner tube 54 such that the body segments 50 are thereby mounted to the tube 54 in order to define the brush head 16. A lower end of the inner tube 54 is open and aligned with an outlet 62 in a lower end of the brush head 16.

In the embodiment shown, the cleaning protrusions comprise both bristles 56 and flexible cleaning fins 58. The bristles 56 comprise standard bristles extending outwardly from the periphery of the body segments 50 and the cleaning fins 58 comprise flexible discs 59 extending outwardly from the periphery of the body segments 50. The flexible discs 59 are formed of a suitable flexible material such as a plastic or silicon based material, and include arm portions 60 extending radially outwardly therefrom. In the embodiment shown, each of the body segments 50 is provided alternately with either bristles 56 or fins 58.

The toilet brush 10 includes also a set of upper bristles 70. The upper bristles 70 extend outwardly from an upper end of the brush head 16. The upper bristles 70 are provided only on one side of the brush head 16 and are angled upwardly relative to a plane transverse to the longitudinal axis of the shaft 12. The upper bristles 70 may therefore be used to clean under a rim of the toilet.

In use, when it is desired to clean the bowl of the toilet, the user may press one of the flexible domes 44 of the flexible covering member 42 to engage a pocket 30 of the tablet sheet 26. This pushes the tablet 28 outwardly through the cover sheet 32 and into the cavity 22 within the handle 14. The tablet 28 then falls downwardly into the first end of the bore 20 of the shaft 12. The tablet 28 passes through the inner tube 54 in the brush head 16 and exits the outlet 62 into the toilet bowl. The tablet 28 can therefore be conveniently dispensed directly into the toilet bowl by simply pressing on one of the domes 44 on the handle 14.

The bristles 56 and cleaning fins 58 may be used to scrub the bowl and the arrangement of the body segments 50 mounted on the flexible inner tube 54 allows the brush head 16 to flex into a curved shape. This allows the brush head 16 to more effectively clean around the bend of the bowl.

The tablet 28 includes a foaming compound to promote outward expansion of the cleaning substance. The tablet 20 may includes a colouring in order to make it readily apparent that the cleaning substance is expanding out into the bowl of the toilet. The cleaning substance thereby assists cleaning and sanitisation of the bowl of the toilet.

It will be readily apparent to persons skilled in the relevant arts that various modifications and improvements may be made to the foregoing embodiments, in addition to those already described, without departing from the basic inventive concepts of the present invention.

1. A toilet brush comprising:
a shaft having a handle at a first end thereof and a brush head at a second end thereof;
a cavity within the handle for receiving a tablet sheet, the tablet sheet including a plurality of pockets in which tablets are received and a cover sheet enclosing the pockets such that the tablets may be dispensed by pushing on the pockets to break the cover sheet; and
a plurality of apertures in the handle through which the pockets of the sheet are accessible;
wherein the shaft includes a bore extending from the handle to adjacent the brush head such that, when dispensed from the sheet, the tablets can fall through the bore such that the tablets may dissolve into a toilet; and
wherein the handle comprises a handle body connected to the shaft and a removable handle cover such that when the handle cover engages with the handle body, the tablet sheet is engaged to hold the tablet sheet in place with the pockets extending through the apertures.

2. The toilet brush in accordance with claim 1, wherein the brush head includes an inner tube in communication with the bore of the shaft such that the tablet falls into the inner tube.

3. The toilet brush in accordance with claim 2, wherein a lower end of the inner tube is located adjacent an outlet in the brush head such that the tablet may fall through the inner tube and outwardly from the brush head through the outlet.

4. The toilet brush in accordance with claim 1, wherein a flexible covering member is provided in the handle having flexible domes extending outwardly through the apertures such that the flexible domes may be depressed to push the tablet outwardly from the tablet sheet into the cavity.

5. The toilet brush in accordance with claim 1, wherein the apertures are provided in a line extending along the length of the handle.

6. The toilet brush in accordance with claim 1, wherein the apertures are provided in the handle cover.

7. The toilet brush in accordance with claim 6, wherein the handle cover comprises an elongate member extending from the first end of the handle to the second end of the handle which is removable by sliding the handle cover longitudinally away from the shaft.

8. The toilet brush in accordance with claim 1, wherein the cavity is provided with a plurality of tabs to engage into indents in edges of the tablet sheet to locate the tablet sheet such that the pockets extend through the apertures.

9. The toilet brush in accordance with claim 7, wherein the indents are provided in opposed longitudinal edges of the tablet sheet.

10. The toilet brush in accordance with claim 1, wherein the tablets include a foaming compound to promote outward expansion of the cleaning substance and a colouring.

11. A toilet brush comprising:
a shaft having a handle at a first end;
a flexible inner tube extending outwardly from a second end thereof; and
a plurality of body segments each including cleaning protrusions extending outwardly from around the periphery thereof;
wherein each of the body segments includes a central hole through which the inner tube is received such that flexing of the inner tube in use allows the angle of the cleaning protrusions on each of the body segments to move out of a plane perpendicular to a longitudinal axis of the shaft, thereby allowing a brush head formed from the adjacent body segments to curve in use.

12. The toilet brush in accordance with claim 11, wherein the body segments each comprises a circular plate arranged such that centres of the body segments are located on a common longitudinal axis.

13. The toilet brush in accordance with claim 12, wherein the cleaning protrusions comprise both bristles and flexible cleaning fins.

14. The toilet brush in accordance with claim 13, wherein the cleaning fins comprise flexible discs extending outwardly from the periphery of the body segments having arm portions extending radially outwardly therefrom.

15. The toilet brush in accordance with claim 14, wherein each of the body segments is provided alternately with either bristles or fins.

16. A tablet sheet for dispensing toilet cleaning tablets comprising:
a plurality of pockets arranged along the length of the tablet sheet from a first end to a second end, each of the pockets being for receiving a dissolvable tablet;
a cover sheet extending across a first side of the tablet sheet to enclose each of the pockets to retain the tablets; and
one or more indents in sides of the tablet sheet to receive lugs in a handle of a toilet brush in order to locate the sheet relative to the handle.

17. The tablet sheet in accordance with claim 16, wherein the indents are provided in opposed longitudinal sides of the tablet sheet.

18. The tablet sheet in accordance with claim 16, wherein indents are provided in upper and lower ends of the tablet sheet.

19. The tablet sheet in accordance with claim 16, wherein the tablets include a foaming compound to promote outward expansion of the cleaning substance.

20. The tablet sheet in accordance with claim 19, wherein the tablets include a colouring.
